(19) United States
(12) Patent Application Publication
(10) Pub. No.: US 2026/0344772 A1
(43) Pub. Date: Nov. 5, 2026

(54) Heating Assembly Comprising A Vacuum Insulator

(71) Applicant: JT International SA, Geneva (CH)

(72) Inventor: Eduardo Jose Garcia Garcia, Grand-Saconnex (CH)

(73) Assignee: JT International SA, Geneva (CH)

(21) Appl. No.: 19/100,021

(22) PCT Filed: Aug. 29, 2023
(86) PCT No.: PCT/EP2023/073608

§ 371 Date: Jan. 30, 2025

(30) Foreign Application Priority Data
Sep. 1, 2022 (EP) 22193483.9

(51) Int. Cl. A24F 40/465; A24F 40/20; A24F 40/46; A24F 40/70; F16L 59/06; H05B 3/46

(52) U.S. Cl. CPC A24F 40/465; A24F 40/46; A24F 40/70; F16L 59/06; H05B 3/46; A24F 40/20; H05B 2203/013; H05B 2203/017

(57) ABSTRACT

A heating assembly for an aerosol generating device. The heating assembly includes: a vacuum insulator having an inner wall and an outer wall between which a vacuum is enclosed. The inner wall defines a cavity having an opening. The cavity extends wherein the cavity extends from a base portion of the inner wall to the opening. The cavity is configured to receive an aerosol generating substrate through the opening. A heater is located within the vacuum on an outer surface of the inner wall of the vacuum insulator. The heater is configured to heat the aerosol generating substrate received within the cavity by thermal conduction to generate an aerosol. The heater is arranged to at least partially surround the cavity on a first portion of the outer surface of the inner wall.

### FIELD OF THE INVENTION

The present invention relates to a heating assembly for an aerosol generating device, a method of manufacturing a heating assembly for an aerosol generating device, and an aerosol generating device comprising a heating assembly. The disclosure is particularly applicable to a portable aerosol generating device, which may be self-contained and low temperature. Such devices may heat, rather than burn, tobacco or other suitable aerosol substrate materials by conduction, convection, and/or radiation, to generate an aerosol for inhalation.

### BACKGROUND

The popularity and use of reduced-risk or modified-risk devices (also known as vaporisers) has grown rapidly in the past few years as an aid to assist habitual smokers wishing to quit using traditional tobacco products such as cigarettes, cigars, cigarillos, and rolling tobacco. Various devices and systems are available that heat or warm aerosolisable substances as opposed to burning tobacco in conventional tobacco products.

A commonly available reduced-risk or modified-risk device is the heated substrate aerosol generation device or heat-not-burn device. Devices of this type generate an aerosol or vapour by heating an aerosol substrate (i.e. consumable) that typically comprises moist leaf tobacco or other suitable aerosolisable material to a temperature typically in the range of 150 °C to 300 °C. Heating an aerosol substrate, but not combusting or burning it, releases an aerosol that comprises the components sought by the user but not the undesirable by-products of combustion. In addition, the aerosol produced by heating the tobacco or other aerosolisable material does not typically comprise the burnt or bitter taste that may result from combustion that can be unpleasant for the user.

Within such aerosol generating devices, it is desirable to improve the efficiency of the heating operation such that the battery life of the device may be extended. To this end, vacuum insulators have been implemented within aerosol generating devices in order to thermally insulate the cavity in which an aerosol substrate is heated, thereby limiting thermal losses to the external environment.

However, during heating of a vacuum insulator within an aerosol generating device, thermal energy from the heater will be conducted along the solid inner wall of the vacuum insulator. This often results in an undesirable distribution of heat with respect to the aerosol substrate which promotes inconsistent and inefficient aerosol generation.

An object of the present invention is to address this problem.

### SUMMARY OF INVENTION

According to first aspect of the invention, there is provided a heating assembly for an aerosol generating device, comprising: a vacuum insulator having an inner wall and an outer wall between which a vacuum is enclosed, wherein the inner wall of the vacuum insulator defines a cavity having an opening, wherein the cavity extends from a base portion of the inner wall to the opening, and wherein the cavity is configured to receive an aerosol generating substrate through the opening; and a heater located within the vacuum on an outer surface of the inner wall of the vacuum insulator, wherein the heater is configured to heat the aerosol generating substrate received within the cavity by thermal conduction to generate an aerosol, wherein a first portion of the inner wall adjacent the heater has a smaller thickness than at least one of: a second portion of the inner wall between the first portion and the opening; and a third portion of the inner wall between the first portion and the base portion.

In this way, due to the variable thickness of the inner wall of the vacuum insulator, the first portion of the inner wall has a higher thermal conductance than the second portion and/or the third portion of the inner wall. In other words, there is a decrease in thermal conductance of the inner wall towards at least one of the opening and the base portion of the inner wall. This minimises the rate of heat transfer from the heater towards the opening and/or the base portion, such that the rate of transfer of thermal energy between the inner wall of the vacuum insulator and the aerosol generating substrate received within the cavity is substantially reduced towards the ends of the aerosol generating substrate.

As will be appreciated by the skilled person, it is preferable to concentrate heating of the aerosol generating substrate away from its ends (i.e. to concentrate heating on the region of the aerosol generating substrate adjacent the heater) in order to optimise the efficiency of aerosol generation. Therefore, it is undesirable for thermal energy to be conducted along the inner wall of the vacuum insulator away from the heater and towards either end of the cavity of the vacuum insulator, as this will result in increased heating of the ends of the aerosol generating substrate. Hence, by providing a thicker portion (i.e. the second portion) of the inner wall between the heater and the opening and/or a thicker portion (i.e. the third portion) of the inner wall between the heater and the base portion, the conduction of heat from the heater towards the base portion and/or the opening is slowed. This means that the rate of heat transfer between the first portion of the inner wall of the vacuum insulator and the aerosol generating substrate is increased, whereas the rate of heat transfer between portions of the inner wall of the vacuum insulator away from the heater (i.e. the second portion, third portion, and optionally further portions of the inner wall beyond the second and third portions) is decreased. Thus, the consistency and efficiency of aerosol generation is improved.

It will be understood that the thickness of the first portion, the second portion, and the third portion of the inner wall of the vacuum refers to the (perpendicular) distance between the inner surface of the inner wall and the outer surface of the inner wall.

It will be understood that the heater being adjacent the first portion of the inner wall means that the heater is adjacent the first portion of the inner wall in a radial direction of the vacuum insulator. In other words, the heater is located on the outer surface of the inner wall such that the heater is at least partially coextensive with the first portion of the inner wall.

The inner surface of the inner wall preferably has a continuous (i.e. planar) surface, whereas the outer surface of the inner wall preferably has a discontinuous (i.e. stepped) surface. The variable thickness of the inner wall is therefore provided by the variable surface height of the outer surface of the inner wall. This means that the thermal conductance of the inner wall of the vacuum insulator may be varied without altering the internal dimensions of the cavity.

The ratio of the thickness of the first portion to the thickness of the second portion and/or the third portion may be 1:1.5 to 1:3, such as 1:2 or 1:2.5. For example, the thickness of the first portion may be 60 μm and the thickness of the second portion and/or the third portion may be 120 μm, i.e. a ratio of 1:2. In another example, the thickness of the first portion may be 80 μm and the thickness of the second portion and/or the third portion may be 120 μm, i.e. a ratio of 1:1.5. In other examples, the thickness of the first portion may be in the range of 40 μm to 80 μm, and the thickness of the second portion and/or the third portion may be in the range of 80 μm to 120 μm.

Preferably, the first portion of the inner wall has a smaller thickness than the second portion of the inner wall. In this way, the rate of heat transfer towards the opening of the cavity is reduced such that the rate of heat transfer between the inner wall of the vacuum insulator and a mouth end of the aerosol generating substrate is also reduced.

Preferably, the first portion of the inner wall has a smaller thickness than the third portion of the inner wall. In this way, the rate of heat transfer towards the base portion of the cavity is reduced such that the rate of heat transfer between the inner wall of the vacuum insulator and an insertion end of the aerosol generating substrate is also reduced.

Preferably, the first portion of the inner wall has a smaller thickness than the second portion of the inner wall and the third portion of the inner wall. In this way, the rate of heat transfer towards both the base portion and the opening is reduced, such that the rate of heat transfer between the inner wall of the vacuum insulator and both the mouth end and the insertion end of the aerosol generating substrate is reduced.

Preferably, the thickness of the inner wall is smallest along the first portion of the inner wall. In this way, the rate of heat transfer from the heater to the first portion of the inner wall of the vacuum insulator is maximised, such that the supply of thermal energy from the inner wall of the vacuum insulator is concentrated away from the mouth end and insertion end of the aerosol generating substrate, i.e. on the region of the aerosol generating substrate adjacent the heater. Thus, the efficiency and consistency of aerosol generation is optimised.

Preferably, the thickness of the inner wall is greatest along the second portion of the inner wall. In this way, the rate of heat transfer from the heater along the inner wall of the vacuum insulator towards the opening is minimised, such that the transfer of thermal energy from the inner wall of the vacuum insulator to the mouth end of the aerosol generating substrate is minimised.

Preferably, the thickness of the inner wall is greatest along the third portion of the inner wall. In this way, the rate of heat transfer from the heater along the inner wall of the vacuum insulator towards the base portion is minimised, such that the transfer of thermal energy from the inner wall of the vacuum insulator to the insertion end of the aerosol generating substrate is minimised.

Preferably, the cavity is tubular.

Preferably, the heater is printed or coated on the outer surface of the inner wall of the vacuum insulator. In this way, reliable thermal contact is provided between the heater and the inner wall of the vacuum insulator.

According to a second aspect of the invention, there is provided a method of manufacturing a heating assembly for an aerosol generating device, comprising: providing an outer wall; providing an inner wall shaped to define a cavity having an opening, wherein the cavity extends from a base portion of the inner wall to the opening, wherein the inner wall comprises a first portion, a second portion and a third portion, wherein the first portion is located between the second portion and the third portion, and wherein the first portion has a smaller thickness than the second portion and/or the third portion; providing a heater on an outer surface of the inner wall adjacent the first portion; coupling the inner wall to the outer wall to form an enclosed space between the outer wall and the inner wall in which the heater is located; and forming a vacuum within the enclosed space between the outer wall and the inner wall.

Preferably, providing the inner wall comprises: stamping a sheet of material to form the inner wall having variable thickness. In this way, the ease of manufacturing the aerosol generating device is improved.

Preferably, providing the heater on the outer surface of the inner wall adjacent the first portion comprises: printing or coating the heater on the outer surface of the inner wall adjacent the first portion. In this way, reliable thermal contact is provided between the heater and the inner wall of the vacuum insulator. Moreover, the ease of manufacturing the aerosol generating device is improved.

### BRIEF DESCRIPTION OF DRAWINGS

Embodiments of the invention are now described, by way of example, with reference to the drawings, in which:

FIG. 1 is a perspective view of an aerosol generating device comprising a heating assembly according to an embodiment of the invention;

FIG. 2 is a perspective schematic view of the heating assembly according to an embodiment of the invention;

FIG. 3 is a cross-sectional schematic view of the heating assembly of FIG. 2; and

FIG. 4 is a flow diagram showing method steps for manufacturing the heating assembly according to an embodiment of the invention.

### DETAILED DESCRIPTION

As described herein, a vapour is generally understood to refer to a substance in the gas phase at a temperature lower than its critical temperature, which means that the vapour can be condensed to a liquid by increasing its pressure without reducing the temperature, whereas an aerosol is a suspension of fine solid particles or liquid droplets, in air or another gas. It should, however, be noted that the terms ‘aerosol’ and ‘vapour’ may be used interchangeably in this specification, particularly with regard to the form of the inhalable medium that is generated for inhalation by a user.

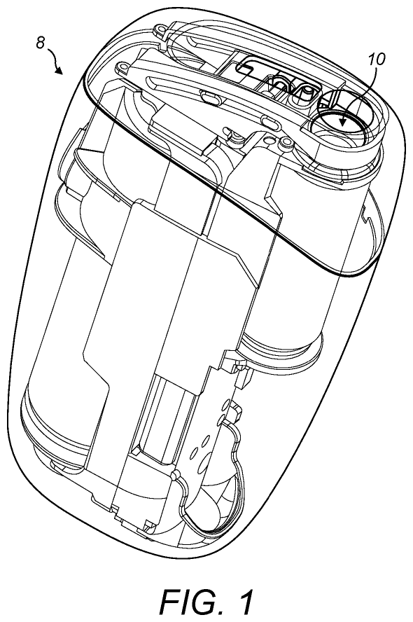

FIG. 1 illustrates an aerosol generating device 8 according to an embodiment of the invention. The aerosol generating device 8 is illustrated in an assembled configuration with exemplary internal components visible. The aerosol generating device 8 is a heat-not-burn device, which may also be referred to as a tobacco-vapour device, and comprises a heating assembly 10 configured to receive an aerosol substrate such as a rod of aerosol generating material, e.g. tobacco. The aerosol generating device 8 may comprise a power source such as a battery and control circuitry for controlling the supply of power from the power source to the heating assembly 10. The heating assembly 10 is operable to heat, but not burn, the rod of aerosol generating material to produce a vapour or aerosol for inhalation by a user. Of course, the skilled person will appreciate that the aerosol generating device 8 depicted in FIG. 1 is simply an exemplary aerosol generating device according to the invention. Other types and configurations of tobacco-vapour products, vaporisers, or electronic cigarettes may also be used as the aerosol generating device according to the invention.

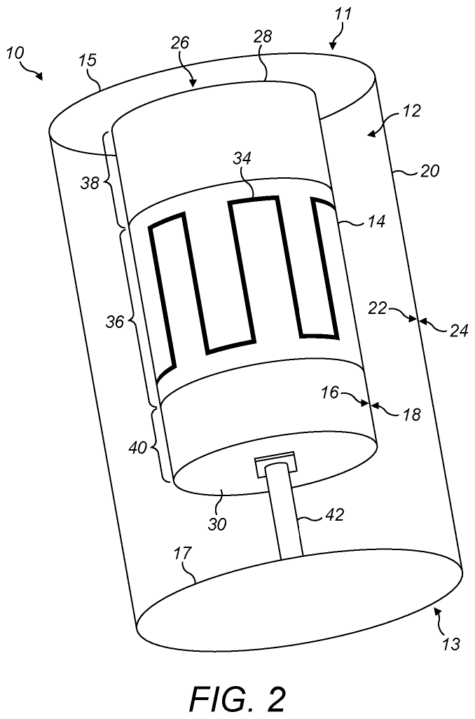

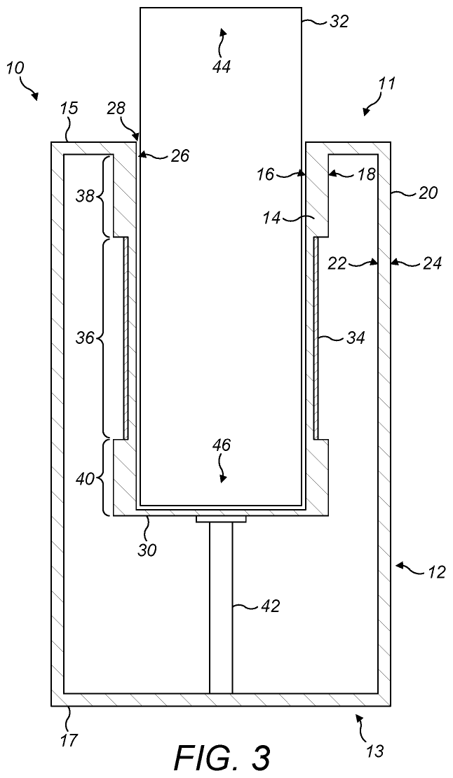

FIG. 2 shows a perspective view of the heating assembly 10 according to an embodiment of the invention. Similarly, FIG. 3 shows a cross-sectional schematic view of the heating assembly 10.

The heating assembly 10 comprises a vacuum insulator 12 having an inner wall 14 and an outer wall 20 between which a vacuum is enclosed. The vacuum insulator 12 extends from a first end 11 to a second end 13, i.e. the vacuum insulator 12 is elongate and defines a longitudinal axis. The vacuum insulator 12 defines a cavity 26 in which an aerosol generating substrate 32 may be received. Specifically, a top portion 15 of the vacuum insulator 12 at the first end 11 has an opening 28 through which the aerosol generating substrate 32 may be inserted into the cavity 26. The vacuum insulator 12 may therefore be referred to as cup-shaped.

The vacuum insulator 12 has an approximately elliptical or circular cross-section when viewed along one of its ends 11, 13, parallel to its longitudinal axis. In particular, in the depicted embodiment, the vacuum insulator 12 is substantially cylindrical. However, in alternative embodiments, the vacuum insulator 12 may be formed in other types of cross-sectional shape, for example shapes that are approximately square or polygonal.

The inner wall 14 of the vacuum insulator 12 is tubular, e.g. substantially cylindrical, and has an outer (e.g. circumferential) surface 18 and an inner (e.g. circumferential) surface 16. The inner wall 14 further comprises a base portion 30. The outer wall 20 is tubular, e.g. substantially cylindrical, and has an outer (e.g. circumferential) surface 24 and an inner (e.g. circumferential) surface 22. The outer wall 20 comprises a base 17 at the second end 13 of the vacuum insulator 12.

The inner wall 14 and the outer wall 20 are spaced radially apart from one another to define an enclosed space between them in which a vacuum is formed. Specifically, in the illustrated embodiment, the inner wall 14 and outer wall 20 are formed as concentric cylinders which are coupled at the first end 11 of the vacuum insulator 12. In a first example, the top portion 15 of the vacuum insulator 12 may be an integral part of the outer wall 20, which is attached to the inner wall 14 at the first end 11. In a second example, the top portion 15 of the vacuum insulator 12 may be an integral part of the inner wall 14, which is attached to the outer wall 20 at the first end 11. In a third example, the top portion 15 of the vacuum insulator 12 may be an additional component that couples the inner wall 14 and the outer wall 20 at the first end 11.

The skilled person will understand that the term “vacuum” refers to a space in which the pressure is considerably lower than atmospheric pressure due to the removal of free matter, in particular air. The quality of the vacuum formed between the inner wall 14 and the outer wall 20 may be a low vacuum, a medium vacuum, or a high vacuum.

The inner wall 14 of the vacuum insulator 12 defines the cavity 26 in which the aerosol generating substrate 32 may be received. In particular, the cavity 26 defined by the inner wall 14 of the vacuum insulator 12 is tubular (e.g. cylindrical) and extends from the base portion 30 to the opening 28. In this way, an aerosol generating substrate 32 in the form of an elongate rod (e.g. cylinder) may be inserted into the cavity 26 via the opening 28, such that the aerosol generating substrate 32 interfaces with the inner surface 16 and the base portion 30 of the inner wall 14. Other than a portion of the aerosol generating substrate 32, which protrudes from the opening 28 to be received in the mouth of a user, the vacuum insulator 12 entirely surrounds the aerosol generating substrate 32 which therefore maximises the effectiveness of the insulation. The skilled person will understand that the cavity 26 is a blind hole, not a through-hole.

Typically, the aerosol generating substrate 32 is a disposable and replaceable article (also known as a “consumable” or heat-not-burn stick) which may, for example, contain tobacco as the aerosol generating material. The aerosol generating substrate 32 has a mouth end 44 and an opposed insertion end 46.

The heating assembly 10 further comprises a heater 34 disposed on the outer surface 18 of the inner wall 14 of the vacuum insulator 12. That is, the heater 34 is located between the inner wall 14 and outer wall 20 of the vacuum insulator 12 within the vacuum. The heater 34 is configured to heat the inner wall 14 of the vacuum insulator 12 by conduction so that the inner wall 14 heats the aerosol generating substrate 32 and the air inside the cavity 26 by conduction and radiation. The heater 34 can be powered by a battery or any other power source provided on an aerosol generating device. For example, the heater 34 may be connectable to an aerosol generating device 8, including control circuitry and a power source such as a battery, via an electrical connector 42. In this way, an electrical circuit may be formed between the power source and the heater 34 via the electrical connector 42. In use, the heater 34 is supplied with electrical power from the power source of the aerosol generating device 8, thereby generating heat by Joule heating. The heat is transferred to the aerosol generating substrate 32 received within the cavity 26 via the inner wall 14 to generate an aerosol for inhalation by the user. In FIGS. 2 and 3, the electrical connector 42 is illustrated as connecting to the base portion 30 of the inner wall 14. However, the skilled person will appreciate that the type and arrangement of the electrical connector 42 may be varied and the heater 34 may be supplied with electricity by various alternative means.

The heater 34 is a resistive heating element that generates heat by resistive heating (also referred to as Joule heating). The heater 34 comprises a heating track (e.g. a sinuous heating pattern) that at least partially surrounds the cavity 26 on the outer surface 18 of the inner wall 14 of the vacuum insulator 12. Specifically, the heating track is wrapped around the inner wall 14 of the vacuum insulator 12 in a circumferential direction, and preferably around the entire circumference of the cavity 26. Advantageously, surrounding the cavity 26 around substantially its full circumference results in the aerosol generating substrate 32 being heated faster or more homogeneously. Of course, the skilled person will appreciate that the particular shape and arrangement of the heater 34 may vary. For example, the heater 34 may comprise a heating sheet which partially or entirely surrounds the outer surface 18 of the inner wall 14 of the vacuum insulator 12.

The heater 34 may be printed, coated or otherwise attached onto the outer surface 18 of the inner wall 14 of the vacuum insulator 12. Thus, the heater 34 may provide “trace heating” to the cavity 26.

The heater 34 may comprise metal (e.g. Nichrome, Kanthal, or Cupronickel), ceramic or any other suitable resistive heating material. As will be appreciated by the skilled person, the heater 34 is not limited to a resistive heating element, and the type of heater 34 may vary. For example, the heater 34 may be an induction heater powered by a coil surrounding the vacuum insulator 12.

As best illustrated in FIG. 3, the thickness of the inner wall 14 of the vacuum insulator 12 varies along the length of the cavity 26, i.e. in a direction defined between the opening 28 and the base portion 30. The inner wall 14 is divided into a plurality of portions including a first portion 36, a second portion 38, and a third portion 40.

The first portion 36 is located adjacent the heater 34. That is, the first portion 36 is a circumferential section of the inner wall 14 that is located alongside the heater 34. In the illustrated embodiment, the first portion 36 is coextensive with the heater 34. However, in alternative embodiments, the first portion 36 may extend beyond the heater 34 in the length direction of the cavity 26, or the heater 34 may extend beyond the first portion 36 in the length direction of the cavity 26.

The second portion 38 is located between the first portion 36 and the opening 28. That is, the second portion 38 is a circumferential section of the inner wall 14 that is arranged between the heater 34 and the opening 28. In the illustrated embodiment, the second portion 38 terminates at the opening 28, i.e. the second portion 38 extends from the first portion 36 to the opening 28. However, in alternative embodiments, the second portion 38 may not extend up to the opening 28 but instead may terminate before the opening 28. In this case, the inner wall 14 may comprise one or more further portions located between the second portion 38 and the opening 28. The further portions may have a thickness greater than or less than the thickness of the second portion 38 and/or the first portion 36.

The third portion 40 is located between the first portion 36 and the base portion 30. That is, the third portion 40 is a circumferential section of the inner wall 14 that is arranged between the heater 34 and the base portion 30. In the illustrated embodiment, the third portion 40 terminates at the base portion 30, i.e. the third portion 40 extends from the first portion 36 to the base portion 30. However, in alternative embodiments, the third portion 40 may not extend up to the base portion 30 but instead may terminate before the base portion 30. In this case, the inner wall 14 may comprise one or more further portions located between the third portion 40 and the base portion 30. The further portions may have a thickness greater than or less than the thickness of the third portion 40 and/or the first portion 36.

The thickness of each of the second portion 38 and the third portion 40 is greater than the thickness of the first portion 36. As thermal conductance is inversely proportional to thickness, a greater thickness will result in a lower rate of heat flow. Therefore, the increased thickness of the second portion 38 and the third portion 40 slows the rate of heat flow towards the opening 28 and the base portion 30 respectively. Advantageously, this means that the temperature of the inner wall 14 of the vacuum insulator 12 is suppressed towards the opening 28 and the base portion 30. Consequently, the regions of the aerosol generating substrate 32 adjacent the opening 28 and the base portion 30 (i.e. the mouth end 44 and the insertion end 46) are supplied with significantly less thermal energy than the region of the aerosol generating substrate 32 between the mouth end 44 and the insertion end 46, i.e. the region of the aerosol generating substrate 32 adjacent the heater 34 or first portion 36. Reducing the thermal energy supplied towards the mouth end 44 and the insertion end 46 of the aerosol generating substrate results in a more efficient and consistent generation of aerosol.

The ratio of the thickness of the first portion 36 to the thickness of the second portion 38 and/or the third portion 40 may be 1:1.5 to 1:3. For example, the thickness of the first portion 36 may be 60 μm and the thickness of the second portion 38 and/or the third portion 40 may be 120 μm, i.e. a ratio of 1:2. In other examples, the thickness of the first portion 36 may be 40 μm to 80 μm, and the thickness of the second portion 38 and/or the third portion 40 may be 80 μm to 120 μm.

The thickness of the inner wall 14 of the vacuum insulator 12 refers to the (perpendicular) distance between the inner surface 16 of the inner wall 14 and the outer surface 18 of the inner wall 14. As illustrated in FIG. 3, the inner surface 16 of the inner wall 14 forms a continuous surface. That is, the (entire) inner surface 16 of the inner wall 14 follows a circumferential plane, such that the inner surface 16 of the inner wall 14 has invariable surface topography.

The variable thickness of the inner wall 14 is therefore provided by the outer surface 18 of the inner wall 14, which is formed as a stepped surface. That is, the outer surface 18 exhibits discontinuous surface topography along the length direction of the inner wall 14. In particular, although each of the first portion 36, the second portion 38, and the third portion 40 individually define continuous outer surfaces (e.g. circumferential planes), the surface height with respect to the cavity 26 of the outer surface 18 along the first portion 36 is discontinuous compared to the surface height with respect to the cavity 26 of the outer surface 18 along the second portion 38 and the third portion 40. Advantageously, this arrangement means that a consistent internal interface is provided for heat transfer from the inner wall 14 to the aerosol generating substrate 32 received within the cavity 26, whilst also providing variable thermal conductance along the length of the inner wall 14.

In the depicted embodiment, the second portion 38 and the third portion 40 are both thicker than the first portion 36. However, in alternative embodiments, only one of the second portion 38 or the third portion 40 may be thicker than the first portion 36, or the inner wall 14 may consist of the first portion 36 and either the second portion 38 or the third portion 40. In addition, in the depicted embodiment, the second portion 38 and the third portion 40 have the same thickness. However, in alternative embodiments, the second portion 38 may be thicker than the third portion 40 or the third portion 40 may be thicker than the second portion 38. Furthermore, in other embodiments, the second portion 38 and/or the third portion 40 may increase in thickness towards the opening 28 and/or the base portion 30 respectively. That is, the outer surface 18 of the inner wall 14 may be sloped with respect to the inner surface 16 of the inner wall 14 along the second portion 38 and/or the third portion 40, such that the thermal conductance of the inner wall 14 decreases towards the opening 28 and/or the base portion 30.

The inner wall 14 of the vacuum insulator 12 may comprise any appropriate material having properties suitable for transmitting heat from the heater 34 into the cavity 26, such as stainless steel or other metals, metal alloys, or ceramics. Examples of suitable materials for the outer wall 20 include stainless steel and/or a plastic such as polyether ether ketone (PEEK).

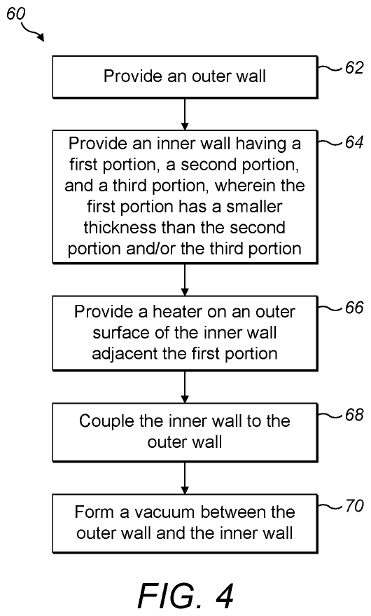

FIG. 4 illustrates a flow chart which is a method 60 of manufacturing a heating assembly 10 according to an embodiment of the invention.

### The Method 60 Begins at Step 62, Wherein an Outer Wall 20 Is Provided.

At step 64, an inner wall 14 is provided. The inner wall 14 is shaped to define a cavity 26 having an opening 28, wherein the cavity 26 extends from a base portion 30 of the inner wall 14 to the opening 28. The inner wall 14 comprises a first portion 36, a second portion 38 and a third portion 40, wherein the first portion 36 is located between the second portion 38 and the third portion 40, and wherein the first portion 36 has a smaller thickness than the second portion 38 and/or the third portion 40.

Optionally, the inner wall 14 may be formed by a stamping (or pressing) process. Specifically, the inner wall 14 may be formed by stamping a sheet of material to form the inner wall 14 including the first portion 36 having a smaller thickness than the second portion 38 and/or the third portion 40. Stamping involves placing the sheet of material into a stamping press, and using a die to form the sheet of material into the inner wall 14. A die is a tool which is pushed into the sheet of material, such that the sheet of material takes the shape of the die.

At step 66, a heater 34 is provided on an outer surface 18 of the inner wall 14 adjacent the first portion 36. For example, the heater 34 may be printed, coated or otherwise fixed to the outer surface 18 of the inner wall 14 alongside the first portion 36.

At step 68, the inner wall 14 is coupled to the outer wall 20 to form an enclosed space between the outer wall 20 and the inner wall 14 in which the heater 34 is located.

Finally, at step 70, a vacuum is formed within the enclosed space between the outer wall 20 and the inner wall 14.

The skilled person will appreciate the shape, properties and configuration of the features discussed with reference to FIGS. 2 and 3 apply equally to the features discussed with reference to method 60.

1. A heating assembly for an aerosol generating device, comprising:
a vacuum insulator having an inner wall and an outer wall between which a vacuum is enclosed, wherein the inner wall of the vacuum insulator defines a cavity having an opening, wherein the cavity extends from a base portion of the inner wall to the opening, and wherein the cavity is configured to receive an aerosol generating substrate through the opening; and
a heater located within the vacuum on an outer surface of the inner wall of the vacuum insulator, wherein the heater is configured to heat the aerosol generating substrate received within the cavity by thermal conduction to generate an aerosol,
wherein the heater is arranged to at least partially surround the cavity on a first portion of the outer surface of the inner wall, and wherein the first portion of the inner wall has a smaller thickness than at least one of: a second portion of the inner wall between the first portion and the opening; and
a third portion of the inner wall between the first portion and the base portion.

2. The heating assembly of claim 1, wherein the first portion of the inner wall has a smaller thickness than the second portion of the inner wall.

3. The heating assembly of claim 1, wherein the first portion of the inner wall has a smaller thickness than the third portion of the inner wall.

4. The heating assembly of claim 1, wherein the first portion of the inner wall has a smaller thickness than the second portion of the inner wall and the third portion of the inner wall.

5. The heating assembly of claim 1, wherein the thickness of the inner wall is smallest along the first portion of the inner wall.

6. The heating assembly of claim 1, wherein the thickness of the inner wall is greatest along the second portion of the inner wall.

7. The heating assembly of claim 1, wherein the thickness of the inner wall is greatest along the third portion of the inner wall.

8. The heating assembly of claim 1, wherein the cavity is tubular.

9. The heating assembly of claim 1, wherein the heater is printed or coated on the outer surface of the inner wall of the vacuum insulator.

10. An aerosol generating device comprising the heating assembly of any claim 1.

11. A method of manufacturing a heating assembly for an aerosol generating device, comprising:
providing an outer wall;
providing an inner wall shaped to define a cavity having an opening, wherein the cavity extends from a base portion of the inner wall to the opening, wherein the inner wall comprises a first portion, a second portion and a third portion, wherein the first portion is located between the second portion and the third portion, and wherein the first portion has a smaller thickness than the second portion and/or the third portion;
providing a heater on an outer surface of the inner wall, wherein the heater is arranged to at least partially surround the cavity on the first portion of the outer surface of the inner wall;
coupling the inner wall to the outer wall to form an enclosed space between the outer wall and the inner wall, wherein the heater is located in the enclosed space; and
forming a vacuum within the enclosed space between the outer wall and the inner wall.

12. The method of manufacturing of claim 11, wherein providing the inner wall comprises: stamping a sheet of material to form the inner wall having variable thickness.

13. The method of manufacturing of claim 11, wherein providing the heater on the outer surface of the inner wall adjacent the first portion comprises: printing or coating the heater on the outer surface of the inner wall adjacent the first portion.
